(19) United States
(12) Patent Application Publication
(10) Pub. No.: US 2017/0132755 A1
(43) Pub. Date: May 11, 2017

(54) METHOD, DEVICE AND SYSTEM FOR PROCESSING IMAGE

(71) Applicants: Le Holdings (Beijing) Co., Ltd., Beijing (CN); LETV SPORTS CULTURE DEVELOP(BEIJING) CO.,LTD., Beijing (CN)

(72) Inventor: Fei LU, Beijing (CN)

(21) Appl. No.: 15/245,209

(22) Filed: Aug. 24, 2016

Related U.S. Application Data
(63) Continuation of application No. PCT/CN2016/082625, filed on May 19, 2016.

(30) Foreign Application Priority Data
Nov. 11, 2015 (CN) 201510767668.3

(51) Int. Cl. G06T 3/40; G06F 3/0484; H04N 1/393

(52) U.S. Cl. CPC G06T 3/40; H04N 1/393; G06F 3/04842; H04L 61/1511

(57) ABSTRACT

Disclosed are a method, a device and a system for processing image. The method includes: receiving an image access request sent by a terminal device, the image access request carrying size information of a requested image, and the size information comprising a width-to-height ratio and width and height of the image; detecting whether the image access request conforms to a preset rule for an image access request; obtaining a target clipping image corresponding to and alike to the requested image in image width-to-height ratio when the image access request conforms to the preset rule for an image access request, the target clipping image being an image obtained by clipping by an image clipping server according to the image width-to-height ratio; shrinking width and height of the target clipping image according to width and height of the requested image; and sending the shrunk image to the terminal device.

### CROSS-REFERENCE TO RELATED APPLICATIONS

This application is a continuation of International Application No. PCT/CN2016/082625, filed on May 19, 2016, which is based upon and claims priority to Chinese Patent Application No. 201510767668.3, filed on Nov. 11, 2015, the entire contents of which are incorporated herein by reference.

### TECHNICAL FIELD

The present disclosure relates to information technologies, and more particularly, to a method, a device and a system for processing image.

### BACKGROUND

With constant development of Internet technologies, use of images in the field of Internet is more and more widely. Particularly in applications installed on a terminal device, images have become indispensable constituent parts. The terminal device may be a computer, a mobile phone or a tablet computer, etc. Generally, different terminal devices have different requirements for displaying the same image. To meet different requirements of different terminal devices, generally images need to be processed to be images of different sizes, and then the processed images are uploaded to a domain name acceleration server, so that the terminal devices can quickly obtain the images.

At present, images are mainly processed artificially, namely, image editing personnel process images according to size display requirements of terminal devices. However, if images are processed artificially, image editing personnel need to reprocess images whenever there are new size display requirements of terminal devices. A great deal of labor cost may be consumed in the presence of a lot of different image size display requirements, which causes lower image processing efficiency.

### SUMMARY

The present disclosure provides a method, a device and a system for processing image to resolve the defect that in the prior art images need to be processed artificially, implement automatic processing of images, and improve image processing efficiency.

In a first aspect, embodiments of the present disclosure provide a method for processing image, implemented by a domain name acceleration server, including:

receiving an image access request sent by a terminal device, the image access request carrying size information of a requested image, and the size information including a width-to-height ratio and width and height of the image;

detecting whether the image access request conforms to a preset rule for an image access request;

obtaining a target clipping image corresponding to and alike to the requested image in image width-to-height ratio when the image access request conforms to the preset rule for an image access request, the target clipping image being an image obtained by clipping by an image clipping server according to the image width-to-height ratio;

shrinking width and height of the target clipping image according to width and height of the requested image; and

sending the shrunk image to the terminal device.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for processing image mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive an inputted image clipping instruction, the image clipping instruction comprising an image and a width-to-height clipping ratio of the image;

clip the image according to the clipping ratio; and

send the clipped image to a domain name acceleration server so that an image of the image access request is obtained by shrinking the clipped image when an image width-to-height ratio in the image access request received by the domain name acceleration server is identical to the clipping ratio but different in width and height.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for processing image in accordance with some embodiments;

FIG. 2 is a flow chart of another method for processing image in accordance with some embodiments;

FIG. 3 is a flow chart of still another method for processing image in accordance with some embodiments;

FIG. 4 is a flow chart of still another method for processing image in accordance with some embodiments;

FIG. 5 is a schematic structural diagram of a domain name acceleration server in accordance with some embodiments;

FIG. 6 is a schematic structural diagram of another domain name acceleration server in accordance with some embodiments;

FIG. 7 is a schematic structural diagram of an image clipping server in accordance with some embodiments;

FIG. 8 is a schematic structural diagram of another image clipping server in accordance with some embodiments;

FIG. 9 is a schematic structural diagram of an image processing system in accordance with some embodiments; and

FIG. 10 is a block diagram of an electronic device in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure.

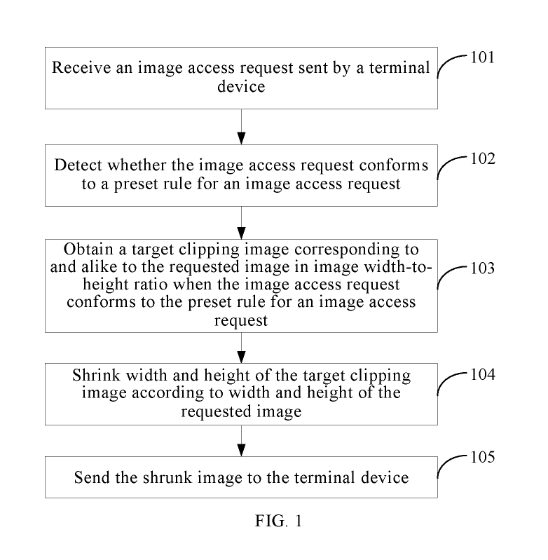

Embodiments of the present disclosure provide a method for processing image, which may be applied to a domain name acceleration server, as shown in FIG. 1, the method includes:

101: The domain name acceleration server receives an image access request sent by a terminal device.

The image access request carries size information of a requested image, and the size information includes a width-to-height ratio and width and height of the image. The terminal device may be a mobile phone, or also may be a computer, a mobile phone or a tablet computer, which is not limited in the embodiments of the present disclosure. For example, the width-to-height ratio is 1:1, and width and height of the image are 300 pixels.

102: The domain name acceleration server detects whether the image access request conforms to a preset rule for an image access request.

The image access request carries a URL corresponding to the requested image. A preset rule for an image access request may be set up according to a user's requirements, or may be set up according to system default mode, which is not limited in the embodiments of the present disclosure. For example, the preset rule for an image access request is that the URL corresponding to the image access request is matched with a preset URL, and the preset URL is generated according to a URL corresponding to a clipped image. Multiple preset URLs may be generated according to URLs corresponding to clipped images.

For example, a URL corresponding to a clipped image is:

http://i1.letvimg.com/yunzhuanma/sms/201408/19/tl130_1/11.jpg. The URL carries the width-to-height ratio (1:1) of the clipped image and a format of the clipped image or the like. A preset URL generated according to a URL corresponding to clipped images may be:

http://i1.letvimg.com/yunzhuanma/sms/201408/19/tl130_1/11_w_h.jpg, where w represents a width size of the image, and h represents a height size of the image. Specifically, the preset URL may be:

http://i1.letvimg.com/yunzhuanma/sms/201408/19/tl130_1/11_200_200.jpg, http://i1.letvimg.com/yunzhuanma/sms/201408/19/tl130_1/11_300_300.jpg, etc.

In addition, the preset URL also may be generated according to a URL corresponding to a clipped image, and an image format and image shrinkage width and height supported by the domain name acceleration server, etc. The image format may be jpg, jpeg, png, gif and so on.

For example, a URL corresponding to a clipped image is:

http://i1.letvimg.com/yunzhuanma/sms/201408/19/tl130_1/11.jpg,

The generated preset URL may be:

http://i1.letvimg.com/yunzhuanma/sms/201408/19/tl130_1/11_500_500.jpeg;

The generated preset URL also may be:

http://i1.letvimg.com/yunzhuanma/sms/201408/19/tl130_1/11_500_500.gif, etc.

In embodiments of the present disclosure, Step 102 specifically may include: detecting whether a URL corresponding to the image access request is matched with the preset URL.

For example, the URL corresponding to the image access request is:

http://i1.letvimg.com/yunzhuanma/sms/201408/19/tl130_1/11_200_200.jpg, a URL generated according to a clipped image is saved on the domain name acceleration server:

http://i1.letvimg.com/yunzhuanma/sms/201408/19/tl130_1/11_200_200.jpg, it is determined that the URL corresponding to the image access request is matched with the preset URL.

103: The domain name acceleration server obtains a target clipping image corresponding to and alike to the requested image in image width-to-height ratio when the image access request conforms to the preset rule for an image access request.

The target clipping image is an image obtained by clipping by an image clipping server according to the image width-to-height ratio.

For example, when the URL corresponding to the image access request is:

http://i1.letvimg.com/yunzhuanma/sms/201408/19/tl130_1/11_300_300.jpg, the requested image is an image whose width-to-height ratio is 1:1 and width and height are 300 pixels, it is obtained a target clipping image corresponding to the requested image, and the target clipping image is an image whose width-to-height ratio is 1:1 and whose width and height are 200 pixels.

104: The domain name acceleration server shrinks width and height of the target clipping image according to width and height of the requested image.

In the embodiments of the present disclosure, Step 104 specifically may include: sending the shrunk image to the terminal device by invoking an image filter module.

For example, width and height of a target clipping smiling face image are shrunk to 300 pixels when the requested image is a smiling face image, a width-to-height ratio corresponding to the requested smiling face image is 1:1, width and height of the image are 300 pixels, and the target clipping smiling face image saved in the domain name acceleration server has a width-to-height ratio of 1:1, and width and height of 200 pixels.

105: The domain name acceleration server sends the shrunk image to the terminal device.

In the embodiments of the present disclosure, by shrinking clipped images, it is directly obtained images meeting requirements for the terminal device, thereby avoiding clipping the same image to be images having different size information artificially, implementing automatic processing of the same image having different sizes, and improving image processing efficiency.

In the embodiments of the present disclosure, after sending the shrunk image to the terminal device, the shrunk image also may be saved. When other terminal devices request an image having the same size as the shrunk image, the shrunk image may be directly sent to the terminal devices, thereby saving system resources consumed by reprocessing the image.

By using the method for processing image provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

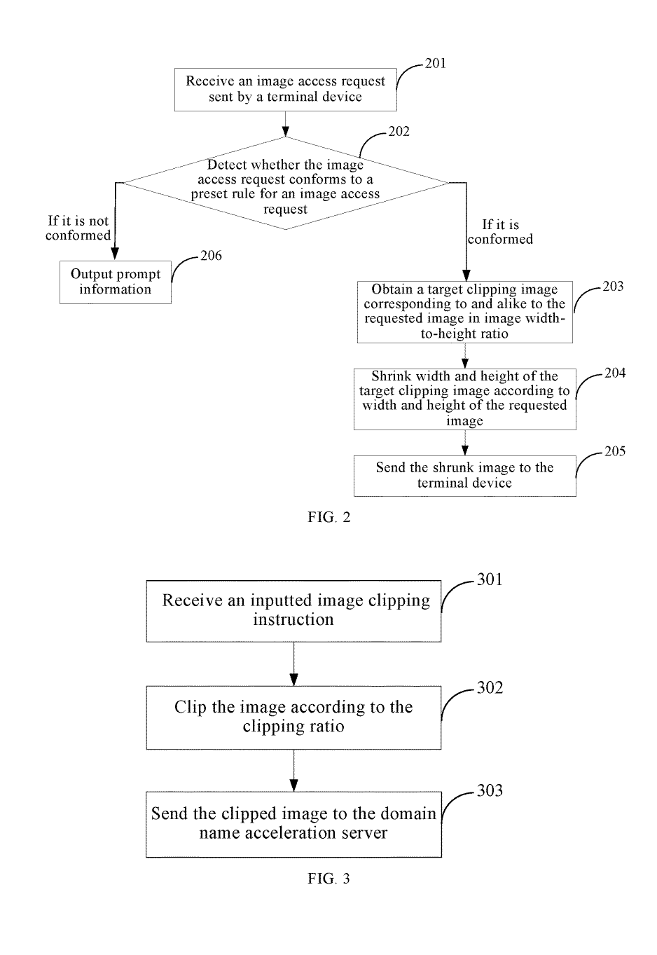

Embodiments of the present disclosure provide another method for processing image, which may be applied to a domain name acceleration server, as shown in FIG. 2, the method includes:

201: The domain name acceleration server receives an image access request sent by a terminal device.

The image access request carries size information of a requested image, and the size information includes a width-to-height ratio and width and height of the image.

In the embodiments of the present disclosure, before Step 201, specifically the method may further include: receiving multiple clipped images sent by the image clipping server, the multiple clipped images being images obtained by clipping different photos by the image clipping server according to different width-to-height ratios; and saving the multiple clipped images.

202: The domain name acceleration server detects whether the image access request conforms to a preset rule for an image access request. Step 203 is executed if the image access request conforms to the preset rule for an image access request, otherwise Step 206 is executed.

The image access request carries a URL corresponding to the requested image, the preset rule for an image access request is that a URL corresponding to an image access request is matched with a preset URL, and the preset URL is generated according to a URL corresponding to a clipped image. Multiple preset URLs may be generated according to URLs corresponding to clipped images. In addition, the preset URL also may be generated according to a URL corresponding to a clipped image, and an image format and image shrinkage width and height supported by the domain name acceleration server, etc.

In embodiments of the present disclosure, Step 202 specifically may include: detecting whether a URL corresponding to the image access request is matched with the preset URL.

203: The domain name acceleration server obtains a target clipping image corresponding to and alike to the requested image in image width-to-height ratio.

The target clipping image is an image obtained by clipping by an image clipping server according to the image width-to-height ratio.

204: The domain name acceleration server shrinks width and height of the target clipping image according to width and height of the requested image.

In the embodiments of the present disclosure, Step 204 specifically may include: sending the shrunk image to the terminal device by invoking an image filter module.

205: The domain name acceleration server sends the shrunk image to the terminal device.

In the embodiments of the present disclosure, by shrinking clipped images, it is directly obtained images meeting requirements for the terminal device, thereby avoiding clipping the same image to be images having different size information artificially, implementing automatic processing of the same image having different sizes, and improving image processing efficiency.

In the embodiments of the present disclosure, after sending the shrunk image to the terminal device, the shrunk image also may be saved. When other terminal devices request an image having the same size as the shrunk image, the shrunk image may be directly sent to the terminal devices, thereby saving system resources consumed by reprocessing the image.

In the embodiments of the present disclosure, after Step 205, the method may further include: synchronizing the shrunk image to various nodes of the domain name server.

206: The domain name acceleration server outputs prompt information.

The prompt information is configured to prompt that the requested image does not conform to a standard. The prompt information may be text prompt information, audio prompt information or image prompt information, which is not limited in the embodiments of the present disclosure. Specifically, the prompt information may be text prompt information prompting that the requested image does not conform to the standard, audio prompt information prompting that the requested image does not conform to the standard, or image prompt information prompting that the requested image does not conform to the standard. By outputting prompt information, a user corresponding to the terminal device may timely know image access situation, thereby improving user experience.

By using another method for processing image provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

Embodiments of the present disclosure provide still another method for processing image, which may be applied to an image clipping server, as shown in FIG. 3, the method includes:

301: The image clipping server receives an inputted image clipping instruction.

The image clipping instruction includes an image and a width-to-height clipping ratio of the image.

In the embodiments of the present disclosure, Step 301 specifically may be as below: when a user selects a certain image on an operation interface of an image processing software on the image clipping server and sets up a clipping box selected on the image, the image clipping server receives the image clipping instruction. By selecting a size and ratio of the clipping box, the user may set up the width-to-height clipping ratio corresponding to the image.

It should be explained that the width-to-height clipping ratio of the image may be one width-to-height clipping ratio or may be different width-to-height clipping ratios, which is not limited in the embodiments of the present disclosure. For example, the width-to-height clipping ratio of the image may be 1:1, or may be 1:2 or 1:3, etc.

302: The image clipping server clips the image according to the clipping ratio.

In the embodiments of the present disclosure, Step 302 specifically may be as below: when the clipping ratio is received by the image processing software installed on the image clipping server, the image is clipped. Specifically, the image may be clipped by the image processing software by invoking an image processing tool.

For example, the image selected by the user is a smiling face image, the width-to-height clipping ratio of the smiling face image is 1:1, and width and height of the smiling face image are respectively 212 pixels. By clipping the smiling face image by the image processing software, size information of the clipped smiling face image is as below: the width-to-height ratio is 1:1, and width and height are 212 pixels*212 pixels.

303: The image clipping server sends the clipped image to the domain name acceleration server.

Further, an image of the image access request is obtained by shrinking the clipped image when an image width-to-height ratio in the image access request received by the domain name acceleration server is identical to the clipping ratio but different in width and height.

In the embodiments of the present disclosure, when the domain name acceleration server receives requested images whose width-to-height ratios are identical to the clipping ratio but different in width and height, by shrinking clipped images, it is directly obtained images meeting requirements for the terminal device, thereby avoiding clipping the same image to be images having different size information artificially, implementing automatic processing of the same image having different sizes, and improving image processing efficiency. When the domain name acceleration server receives requested images whose width-to-height ratios are identical to the clipping ratio but different in width and height, the clipped image may be directly sent to the terminal device.

In the embodiments of the present disclosure, Step 303 specifically may be as below: the clipped image is saved in a memory device in advance, and the clipped image is sent to the domain name acceleration server after receiving notification information sent by the user. Or the clipped image is directly sent to the domain name acceleration server. It can be ensured a velocity at which the user obtains images by sending the clipped image to the domain name acceleration server.

For example, when a requested image in the image access request received by the domain name acceleration server is a smiling face image and the width-to-height ratio of the requested smiling face image is 1:1, and width and height thereof are 200 pixels, the domain name acceleration server shrinks a clipped smiling face image whose width and height are 212 pixels sent by the image clipping server to be a smiling face image whose width and height are 200 pixels. When the requested image in the image access request received by the domain name acceleration server is a smiling face image and the width-to-height ratio of the requested smiling face image is 1:1 and width and height are 500 pixels, the domain name acceleration server shrinks a clipped smiling face image whose width and height are 212 pixels sent by the image clipping server to be a smiling face image whose width and height are 500 pixels. In the embodiments of the present disclosure, cost and time consumed by processing the smiling face image artificially can be saved by automatically processing the smiling face image to be a smiling face image whose width and height are 200 pixels or 500 pixels, thereby improving the processing efficiency of the smiling face image.

By using the still another method for processing image provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

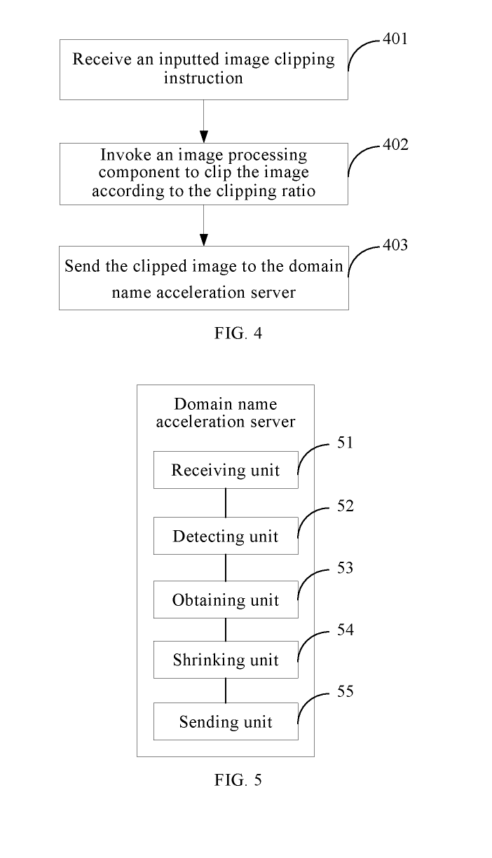

Embodiments of the present disclosure provide still another method for processing image, which may be applied to an image clipping server, as shown in FIG. 4, the method includes:

401: The image clipping server receives an inputted image clipping instruction.

The image clipping instruction includes an image and a width-to-height clipping ratio of the image.

402: The image clipping server invokes an image processing component to clip the image according to the clipping ratio.

The image processing component may be a component in image processing software installed on the image clipping server. Specifically, the image processing component may be an image processing tool GraphicsMagick.

403: The image clipping server sends the clipped image to the domain name acceleration server.

Further, an image of the image access request is obtained by shrinking the clipped image when the image width-to-height ratio in the image access request received by the domain name acceleration server is identical to the clipping ratio. In the embodiments of the present disclosure, when the domain name acceleration server receives requested images whose width-to-height ratios are identical to the clipping ratio but different in width and height, by shrinking clipped images, it is directly obtained images meeting requirements for the terminal device, thereby avoiding clipping the same image to be images having different size information artificially, implementing automatic processing of the same image having different sizes, and improving image processing efficiency. When the domain name acceleration server receives requested images whose width-to-height ratios are identical to the clipping ratio and identical in width and height, the clipped image may be directly sent to the terminal device.

By using the still another method for processing image provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

Further, as a concrete implementation of the method as shown in FIG. 1, embodiments of the present disclosure provide a domain name acceleration server, as shown in FIG. 5, the domain name acceleration server includes: a receiving unit 51, a detecting unit 52, an obtaining unit 53, a shrinking unit 54 and a sending unit 55.

The receiving unit 51 is configured to receive an image access request sent by a terminal device, where the image access request carries size information of a requested image, and the size information includes a width-to-height ratio and width and height of the image. The terminal device may be a mobile phone, or also may be a computer, a mobile phone or a tablet computer, which is not limited in the embodiments of the present disclosure.

The detecting unit 52 is configured to detect whether the image access request conforms to a preset rule for an image access request.

The image access request carries a URL corresponding to the requested image. A preset rule for an image access request may be set up according to a user's requirements, or may be set up according to a system default mode, which is not limited in the embodiments of the present disclosure.

The obtaining unit 53 is configured to obtain a target clipping image corresponding to and alike to the requested image in image width-to-height ratio when the image access request conforms to the preset rule for an image access request, where the target clipping image is an image obtained by clipping by an image clipping server according to the image width-to-height ratio.

The shrinking unit 54 is configured to shrink width and height of the target clipping image according to width and height of the requested image.

The sending unit 55 is configured to send the shrunk image to the terminal device.

It should be explained that reference may be made to corresponding description in FIG. 1 for other corresponding description of various function units involved with the domain name acceleration server provided by the embodiments of the present disclosure, which is not repeated any more herein.

By using the domain name acceleration server provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

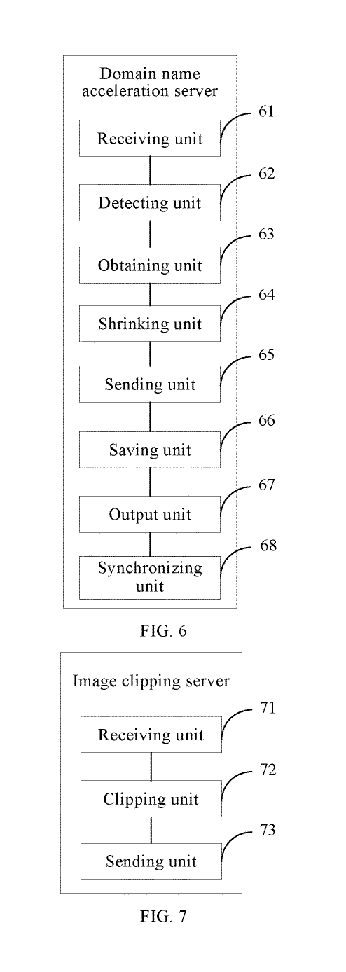

Further, as a concrete implementation of the method as shown in FIG. 2, embodiments of the present disclosure provide another domain name acceleration server, as shown in FIG. 6, the domain name acceleration server includes: a receiving unit 61, a detecting unit 62, an obtaining unit 63, a shrinking unit 64 and a sending unit 65.

The receiving unit 61 is configured to receive an image access request sent by a terminal device, where the image access request carries size information of a requested image, and the size information includes a width-to-height ratio and width and height of the image.

The detecting unit 62 is configured to detect whether the image access request conforms to a preset rule for an image access request.

The obtaining unit 63 is configured to obtain a target clipping image corresponding to and alike to the requested image in image width-to-height ratio when the image access request conforms to the preset rule for an image access request, where the target clipping image is an image obtained by clipping by an image clipping server according to the image width-to-height ratio.

The shrinking unit 64 is configured to shrink width and height of the target clipping image according to width and height of the requested image.

The sending unit 65 is configured to send the shrunk image to the terminal device.

The apparatus further includes: a saving unit 66.

The receiving unit 61 is further configured to receive multiple clipped images sent by an image clipping server, the multiple clipped images are images obtained by clipping different photos by the image clipping server according to different width-to-height ratios.

The saving unit 66 is configured to save the multiple clipped images.

The image access request carries a URL corresponding to the requested image, the preset rule for an image access request is that a URL corresponding to an image access request is matched with a preset URL, and the preset URL is generated according to a URL corresponding to a clipped image.

The detecting unit 62 is specifically configured to detect whether a URL corresponding to the image access request is matched with the preset URL.

The apparatus further includes: an output unit 67.

The output unit 67 is configured to output prompt information when the image access request does not conform to the preset rule for an image access request, where the prompt information is configured to prompt that the requested image does not conform to a standard.

The apparatus further includes: a synchronizing unit 68.

The synchronizing unit 68 is configured to synchronize the shrunk image to various nodes of a domain name server.

It should be explained that reference may be made to corresponding description in FIG. 2 for other corresponding description of various function units involved with another domain name acceleration server provided by the embodiments of the present disclosure, which is not repeated any more herein.

By using the domain name acceleration server provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

Further, as a concrete implementation of the method as shown in FIG. 3, embodiments of the present disclosure provide an image clipping server, as shown in FIG. 7, the image clipping server includes: a receiving unit 71, a clipping unit 72 and a sending unit 73.

The receiving unit 71 is configured to receive an inputted image clipping instruction, where the image clipping instruction includes an image and a width-to-height clipping ratio of the image.

The clipping unit 72 is configured to clip the image according to the clipping ratio.

The sending unit 73 is configured to send the clipped image to the domain name acceleration server.

Further, an image of the image access request is obtained by shrinking the clipped image when an image width-to-height ratio in the image access request received by the domain name acceleration server is identical to the clipping ratio but different in width and height.

It should be explained that reference may be made to corresponding description in FIG. 3 for other corresponding description of various function units involved with the image clipping server provided by the embodiments of the present disclosure, which is not repeated any more herein.

By using the image clipping server provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

Further, as a concrete implementation of the method as shown in FIG. 4, embodiments of the present disclosure provide another image clipping server, as shown in FIG. 8, the image clipping server includes: a receiving unit 81, a clipping unit 82 and a sending unit 83.

The receiving unit 81 is configured to receive an inputted image clipping instruction, where the image clipping instruction includes an image and a width-to-height clipping ratio of the image.

The clipping unit 82 is configured to clip the image according to the clipping ratio.

The sending unit 83 is configured to send the clipped image to the domain name acceleration server.

Further, an image of the image access request is obtained by shrinking the clipped image when an image width-to-height ratio in the image access request received by the domain name acceleration server is identical to the clipping ratio but different in width and height.

It should be explained that reference may be made to corresponding description in FIG. 4 for other corresponding description of various function units involved with another image clipping server provided by the embodiments of the present disclosure, which is not repeated any more herein.

By using another image clipping server provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

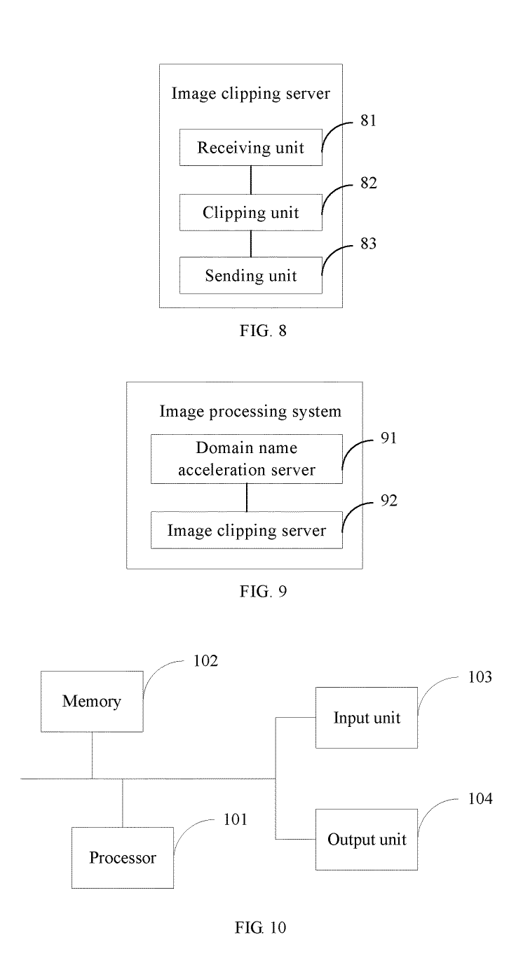

Further, embodiments of the present disclosure provide an image processing system, as shown in FIG. 9, including: a domain name acceleration server 91 and an image clipping server 92.

The domain name acceleration server 91 is configured to: receive an image access request sent by a terminal device, where the image access request carries size information of a requested image, and the size information includes a width-to-height ratio and width and height of the image; detect whether the image access request conforms to a preset rule for an image access request; obtain a target clipping image corresponding to and alike to the requested image in image width-to-height ratio when the image access request conforms to the preset rule for an image access request, where the target clipping image is an image obtained by clipping by the image clipping server 92 according to the image width-to-height ratio; shrink width and height of the target clipping image according to width and height of the requested image; and send the shrunk image to the terminal device.

The image clipping server 92 is configured to: receive an inputted image clipping instruction, where the image clipping instruction includes an image and a width-to-height clipping ratio of the image; clip the image according to the clipping ratio; and send the clipped image to the domain name acceleration server 91.

By using the image processing system provided by the embodiments of the present disclosure, the same photo is clipped according to requirements for different width-to-height ratios to obtain multiple clipped images; when the image width-to-height ratio requested by a terminal device is identical to ratios of the clipped images, the clipped images are directly shrunk according to width and height of the requested image, thereby changing the defect that in the prior art images need to be processed artificially, implementing automatic processing of images, and improving image processing efficiency.

Further, an embodiment of the present disclosure further provides a non-transitory computer-readable storage medium storing executable instructions, which can be executed by an electronic device to perform any methods for processing image mentioned by embodiments of the present disclosure.

FIG. 10 is a block diagram of an electronic device which is configured to perform the methods for processing image according to an embodiment of the present disclosure. As shown in FIG. 10, the device includes: one or more processors 101 and memory 102. A processor 101 is showed in FIG. 10 for an example.

Device which is configured to perform the methods for processing image can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for processing image mentioned by embodiments of the present disclosure (such as shown in FIG. 5, receiving unit 51, detecting unit 52, obtaining unit 53, shrinking unit 54 and sending unit 55). Processor 101 performs kinds of functions and processing image of the electronic device by executing non-transitory software program, instructions and modules which are stored in memory 102, thereby realizes the methods for processing image mentioned by embodiments of the present disclosure.

Memory 102 can include program storage area and data storage area, thereby the operating system and applications required by at least one function can be stored in program storage area and data created by using the device for processing image can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for processing image by networks. The examples of said networks are including but not limited to Internet, Intranet, LAN, mobile Internet and their combinations.

Input unit 103 can be used to receive inputted number, character information and key signals causing user configures and function controls of the device for processing image. Output unit 104 can include a display screen or a display device.

The said module or modules are stored in memory 102 and perform the methods for processing image when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiments set forth above is merely exemplary, where units described as detached parts can be or not be detachable physically; parts displayed as units can be or not be physical units, i.e., either located at the same place, or distributed on a plurality of network units. Modules may be selected in part or in whole according to actual needs for achieving objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (a personal computer, or a server, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for processing image, implemented by a domain name acceleration server, comprising:
receiving an image access request sent by a terminal device, the image access request carrying size information of a requested image, and the size information comprising a width-to-height ratio and width and height of the image;
detecting whether the image access request conforms to a preset rule for an image access request;
obtaining a target clipping image corresponding to and alike to the requested image in image width-to-height ratio when the image access request conforms to the preset rule for an image access request, the target clipping image being an image obtained by clipping by an image clipping server according to the image width-to-height ratio;
shrinking width and height of the target clipping image according to width and height of the requested image; and
sending the shrunk image to the terminal device.

2. The method for processing image according to claim 1, wherein before receiving an image access request sent by a terminal device, the method further comprises:
receiving multiple clipped images sent by the image clipping server, the multiple clipped images being images obtained by clipping different photos by the image clipping server according to different width-to-height ratios; and
saving the multiple clipped images.

3. The method for processing image according to claim 1, wherein the image access request carries a URL corresponding to the requested image; the preset rule for an image access request is that a URL corresponding to an image access request is matched with a preset URL; and the preset URL is generated according to a URL corresponding to a clipped image.

4. The method for processing image according to claim 3, wherein the detecting whether the image access request conforms to a preset rule for an image access request comprises:
detecting whether a URL corresponding to the image access request is matched with the preset URL.

5. The method for processing image according to claim 1, wherein after detecting whether the image access request conforms to a preset rule for an image access request, the method further comprises:
outputting prompt information when the image access request does not conform to the preset rule for an image access request, wherein the prompt information is configured to prompt that the requested image does not conform to a standard.

6. The method for processing image according to claim 1, wherein after sending the shrunk image to the terminal device, the method further comprises:
synchronizing the shrunk image to various nodes of a domain name server.

7. An electronic device, comprising:
at least one processor; and
a memory communicably connected with the at least one processor for storing instructions executable by the at least one processor, wherein execution of the instructions by the at least one processor causes the at least one processor to:
receive an image access request sent by a terminal device, the image access request carrying size information of a requested image, and the size information comprising a width-to-height ratio and width and height of the image;
detect whether the image access request conforms to a preset rule for an image access request;
obtain a target clipping image corresponding to and alike to the requested image in image width-to-height ratio when the image access request conforms to the preset rule for an image access request, the target clipping image being an image obtained by clipping by an image clipping server according to the image width-to-height ratio;
shrink width and height of the target clipping image according to width and height of the requested image; and
send the shrunk image to the terminal device.

8. The electronic device according to claim 7, wherein the instructions are executed to cause the at least one processor to:
receive multiple clipped images sent by an image clipping server, wherein the multiple clipped images are images obtained by clipping different photos by the image clipping server according to different width-to-height ratios; and
save the multiple clipped images.

9. The electronic device according to claim 7, wherein the image access request carries a URL corresponding to the requested image; the preset rule for an image access request is that a URL corresponding to an image access request is matched with a preset URL; and the preset URL is generated according to a URL corresponding to a clipped image.

10. The electronic device according to claim 9, wherein the instructions are executed to cause the at least one processor to:
detect whether a URL corresponding to the image access request is matched with the preset URL.

11. The electronic device according to claim 7, wherein the instructions are executed to cause the at least one processor to:
output prompt information when the image access request does not conform to the preset rule for an image access request, wherein the prompt information is configured to prompt that the requested image does not conform to a standard.

12. The electronic device according to claim 7, wherein the instructions are executed to cause the at least one processor to:
synchronize the shrunk image to various nodes of a domain name server.

13. An electronic device, comprising:
at least one processor; and
a memory communicably connected with the at least one processor for storing instructions executable by the at least one processor, wherein execution of the instructions by the at least one processor causes the at least one processor to:
receive an inputted image clipping instruction, the image clipping instruction comprising an image and a width-to-height clipping ratio of the image;
clip the image according to the clipping ratio; and
send the clipped image to a domain name acceleration server so that an image of the image access request is obtained by shrinking the clipped image when an image width-to-height ratio in the image access request received by the domain name acceleration server is identical to the clipping ratio but different in width and height.

14. The electronic device according to claim 13, wherein the clipping the image according to the clipping ratio comprises:
invoking an image processing component to clip the image according to the clipping ratio.
